(19) United States
(12) Patent Application Publication
(10) Pub. No.: US 2007/0201245 A1
(43) Pub. Date: Aug. 30, 2007

(54) Optical sheet

(75) Inventor: Shao-Han Chang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Chen City (TW)

(21) Appl. No.: 11/521,920

(22) Filed: Sep. 15, 2006

(30) Foreign Application Priority Data
Feb. 25, 2006 (CN) 200610033966.0

(51) Int. Cl. F21V 7/04

(52) U.S. Cl. 362/627

(57) ABSTRACT

An optical sheet (20) includes a main body. The main body includes an incident surface (22), an emitting surface (23) at the opposite side of the incident surface, and a plurality of inverted pyramid depressions (24) formed on the emitting surface.

### CROSS-REFERENCE TO RELATED APPLICATIONS

This application is related to co-pending U.S. Patent Application, entitled “BACKLIGHT MODULE”, by Shao-Han Chang. Such applications have the same assignee as the present application and have been concurrently filed herewith. The disclosure of the above identified application is incorporated herein by reference.

### BACKGROUND OF THE INVENTION

1. Field of the Invention

The present invention relates to optical sheets, more particularly, to an optical sheet and backlight module using the same for use in, for example, a liquid crystal display (LCD).

2. Discussion of the Related Art

In a liquid crystal display device, a liquid crystal is a substance that does not itself radiate light. Instead, the liquid crystal relies on light received from a light source, thereby displaying images and data. In the case of a typical liquid crystal display device, a backlight module powered by electricity supplies the needed light.

FIG. 7 represents a typical backlight module 10. The backlight module 10 includes a housing 11, a plurality of lamp tubes 12, a light diffusion plate 13, a first light diffusion sheet 14, a first prism sheet 15, a second prism sheet 16 and a second light diffusion sheet 17. The housing 11 has an opening 112 located on a top thereof. The light diffusion plate 13, the first light diffusion sheet 14, the first prim sheet 15, the second prism sheet 16, and the second light diffusion sheet 17 are stacked in that order on the opening 112 of the housing 11. The lamp tubes 12 are positioned in the housing 11 under the light diffusion plate 13. It is noted that the light diffusion plate 13 is significantly needed to improve the backlight module 10's optical uniformity for decreasing potential dark strips caused by the reduced intensity of light between adjacent to the lamp tubes 12. In addition, the light diffusion plate 13 is required to have enough mechanical intensity to support the first light diffusion sheet 14, the first prim sheet 15, the second prism sheet 16, and the second light diffusion sheet 17. Thus, a thickness of the light diffusion plate 13 is required to be in a range of about 2 to 3 centimeters, and is much larger than both that of the first and second light diffusion sheet 14 and 17. Therefore, the light rays emitted from the lamp tubes 12 are substantially diffused in the light diffusion plate 13, and finally surface light rays are output from the second light diffusion sheet 17.

However, referring to FIG. 8, the light diffusion plate 13 is typically manufactured by uniformly dispersing a plurality of light diffusion particles 132 into transparent resin matrix materials 131. The light diffusion particles 132 may be selected from a group comprising of silicon dioxide (SiO₂) particles and titanium dioxide (TiO₂) particles. Since the light rays are diffused at the light diffusion particles 132 many times in the light diffusion plate 13, an amount of the light energy would have been consumed in the light rays' diffusing process, thus a light brightness of the backlight module 10 is decreased.

In addition, the two prism sheets 15 and 16 of the backlight module 10 each have a plurality of elongated prism lenses (not shown) parallel to each other, but the prism lenses of the two prism sheets 15 and 16 extends along different directions correspondingly. The two prism sheets 15 and 16 cooperatively increase the backlight module 10's light brightness. Although the two prism sheets 15 and 16 can help increase the light brightness of the backlight module 10, the backlight module 10 still has a relatively low light brightness compared with high brightness backlight modules. In use, the light diffusion plate 13, the first light diffusion sheet 14, the first prim sheet 15, the second prism sheet 16 and the second light diffusion sheet 17 are in contact with each other, however, a plurality of air pockets exists at the boundaries between the above mentioned optical members. When light rays pass through the air pockets, some of the light rays would have been consumed by total reflecting, thus, affecting the light energy utilization rate of the backlight module 10. Furthermore, the light diffusion plate 13, and the two prism sheets 15 and 16 have a high production cost in manufacturing the backlight module 10.

What is needed, therefore, is a new optical sheet that overcome the above mentioned shortcomings.

### SUMMARY

An optical sheet according to a preferred embodiment includes a main body. The main body includes an incident surface, an emitting surface opposite to the incident surface, and a plurality of inverted pyramid depressions formed on the emitting surface.

Other advantages and novel features will become more apparent from the following detailed description of the preferred embodiments, when taken in conjunction with the accompanying drawings.

### BRIEF DESCRIPTION OF THE DRAWINGS

Many aspects of the present optical sheet can be better understood with reference to the following drawings. The components in the drawings are not necessarily drawn to scale, the emphasis instead being placed upon clearly illustrating the principles of the present optical sheet. Moreover, in the drawings, like reference numerals designate corresponding parts throughout the several views.

FIG. 1 is a schematic, isometric view of an optical sheet according to a first preferred embodiment;

FIG. 2 is a schematic, top plan view of the optical sheet of FIG. 1;

FIG. 3 is an enlarged, partially cross-sectional view taken along a III-III line of FIG. 2;

FIG. 4 is a schematic, partially cross-sectional view of an optical sheet according to a second preferred embodiment;

FIG. 5 is a schematic, partially cross-sectional view of an optical sheet according to a third preferred embodiment;

FIG. 6 is a schematic, partially cross-sectional view of an optical sheet according to a fourth preferred embodiment;

FIG. 7 is a schematic, cross-sectional view of a conventional backlight module; and

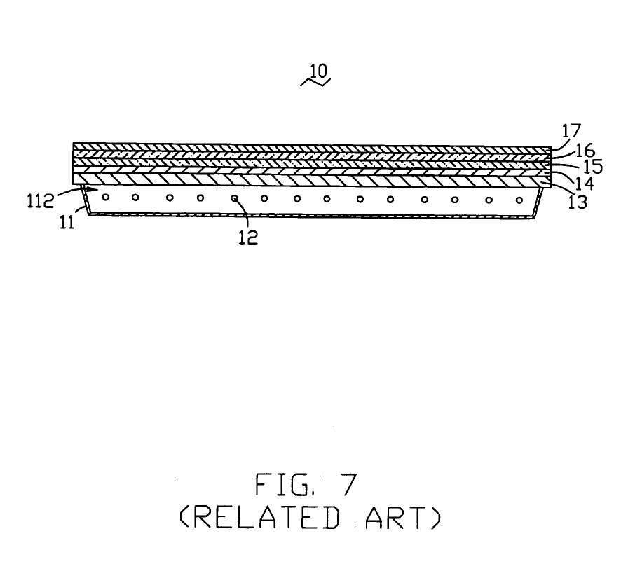

FIG. 8 is an enlarged, partially, cross-sectional view of a conventional light diffusion plate of the backlight module of FIG. 7.

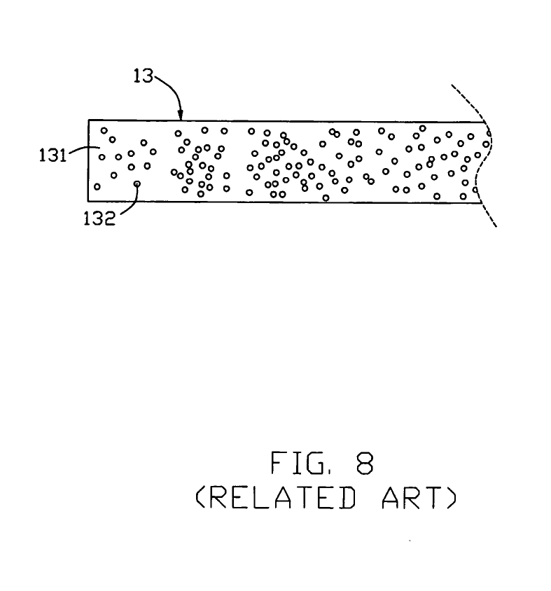

### DETAILED DESCRIPTION OF THE PREFERRED EMBODIMENTS

Reference will now be made to the drawings to describe preferred embodiments of the present optical sheet, in detail.

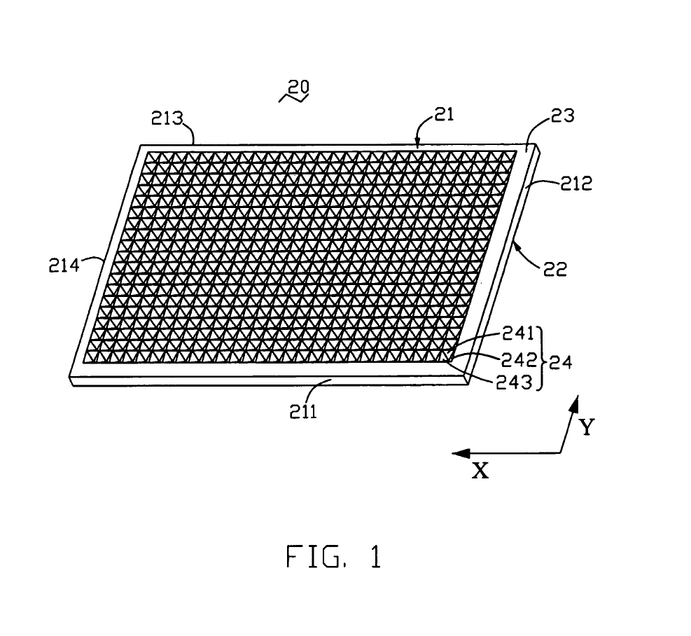

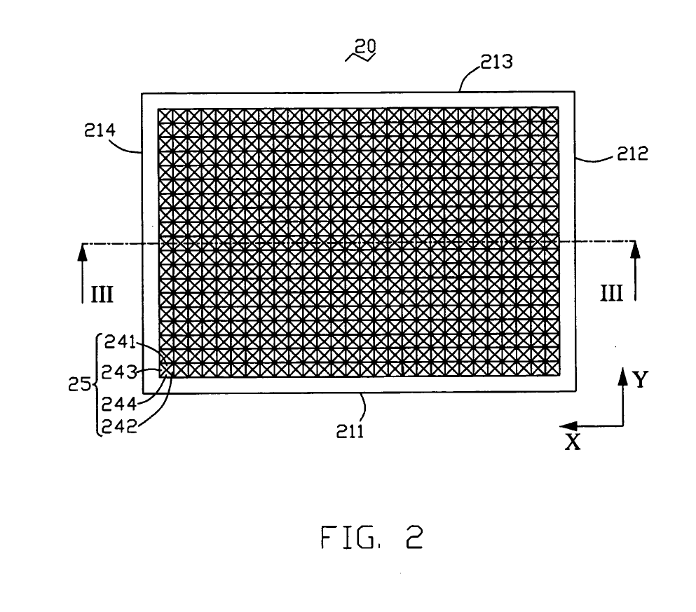

Referring to FIGS. 1 and 2, an optical sheet 20 in accordance with a first preferred embodiment is shown. The optical sheet 20 includes a rectangular main body 21. The main body 21 includes an incident surface 22, an emitting surface 23 positioned opposite to the incident surface 22, and four side surfaces 211, 212, 213 and 214 connecting the incident surface 22 and the emitting surface 23. A plurality of inverted rectangular pyramid depressions 24 are defined on the emitting surface 23. The incident surface 22 is a planar surface. A material of the main body 21 employs transparent resin materials, and the material is preferably selected from polymethyl methacrylate (PMMA) and polycarbonate (PC).

In this embodiment, the inverted rectangular pyramid depressions 24 are distributed on the emitting surface 23 in a matrix manner, and are aligned side by side. Each inverted rectangular pyramid depression 24 is configured to be an inverted square pyramid having four inner side surfaces 241, 242, 243, and 244. The four inner side surfaces 241, 242, 243, and 244 have similar triangular shapes.

Also referring to FIGS. 1 and 2, two opposite inner side surfaces 241 and 244 of each inverted rectangular pyramid depression 24 are both parallel to a first direction (hereinafter, referred to an X-axis direction shown in FIGS. 1 and 2). The other opposite inner side surfaces 242 and 243 of each inverted rectangular pyramid depression 24 are both parallel to a second direction (hereinafter, referred to an Y-axis direction shown in FIGS. 1 and 2). The X-axis direction is perpendicular to the Y-axis direction. In this embodiment, the side surfaces 211 and 213 of the main body 21 are parallel to the X-axis direction and the side surfaces 212 and 214 of the main body 21 are parallel to the Y-axis direction. It should be noted that the two opposite side surfaces 211 and 214 are configured to be slanted in respect to the X-axis direction and the other two opposite side surfaces 212 and 213 are configured to be slanted in respect to the Y-axis direction.

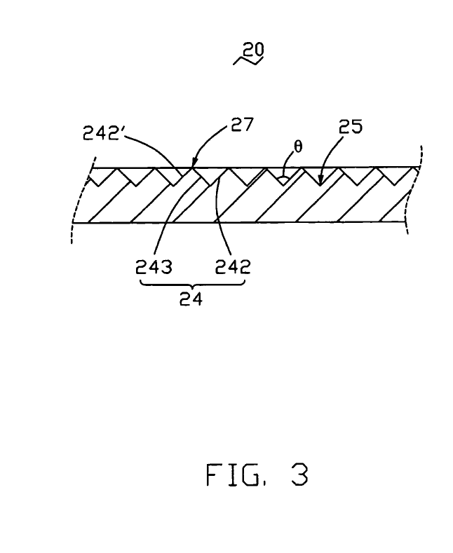

Referring to FIGS. 2 and 3, the four inner side surfaces 241, 242, 243, and 244 of each inverted rectangular pyramid depression 24 cooperatively defines a valley 25. One inner side surface 243 of each inverted rectangular pyramid depression 24 and an inner side surface 242′ of the adjacent inverted rectangular pyramid depression 24′ connected with the inner side surface 243 cooperatively defines a ridge 27.

An inclination angle θ defined by one of two opposite inner side surfaces 242 and 243 (or 241 and 244) of each inverted rectangular pyramid depression 24 is configured to be in the range of about 45 degrees to about 135 degrees. In this embodiment, the inclination angle θ is preferably configured to be 90 degrees.

Light emitting angles and the brightness gain of the optical sheet 20 may be controlled by varying the inclination angles θ. Furthermore, the ridges defined by the inverted rectangular pyramid depressions 24 of the optical sheet 20 extend along the X-axis direction and the Y-axis direction respectively, the optical sheet 20 have excellent capabilities in increasing the light brightness. It is also said that the two prism sheets 15 and 16 of the conventional backlight module 10 are integrally combined into the present optical sheet. Accordingly, the optical sheet 20 can increase the light energy utilization rate by avoiding a plurality of air pockets between the boundaries between the two prism sheets 15 and 16.

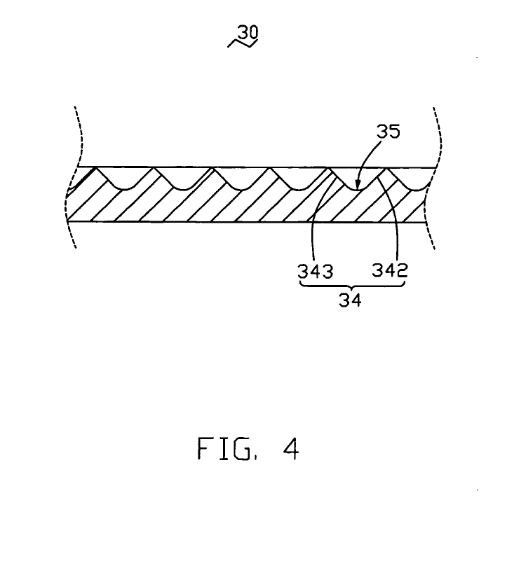

Referring to FIG. 4, an optical sheet 30, in accordance with a second preferred embodiment, is similar in principle to the optical sheet 20, except that valleys 35 defined by four inner side surfaces 342 and 343 (the other inner side surfaces are not shown) of the inverted rectangular pyramid depressions 34 are curved, i.e., the inverted rectangular pyramid depressions 34 are configured to have a round top.

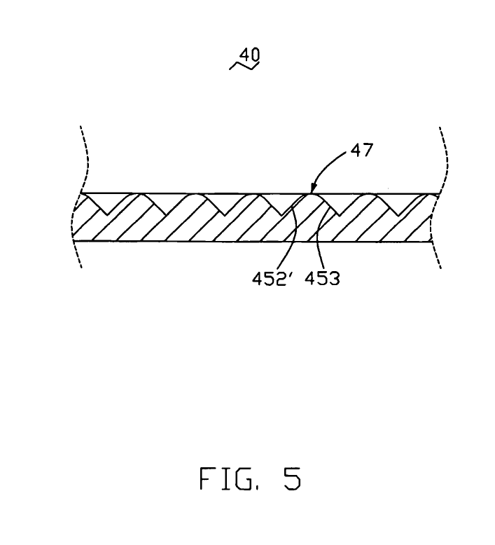

Referring to FIG. 5, an optical sheet 40, in accordance with a third preferred embodiment, is similar in principle to the optical sheet 20, except that ridges 47 defined by inner side surfaces 452′ and 453 of the adjacent inverted rectangular pyramid depressions 34 are curved.

It is to be understood that the valleys and the ridges defined by the inverted rectangular pyramid depressions of the present optical sheet may be both curved. This configuration may increase optical uniformity of the present optical sheet, by avoiding a sudden change to the refractions of the light rays projecting along the ridges that decrease the optical uniformity.

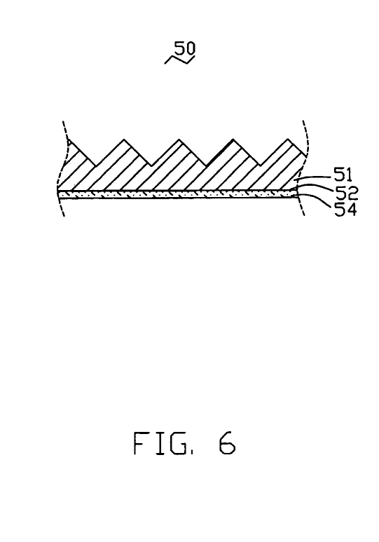

Referring to FIG. 6, an optical sheet 50, in accordance with a third preferred embodiment, is similar in principle to the optical sheet 20, except that the optical sheet 50 further includes a light diffusion layer 54 formed on an incident surface 52 of the optical sheet 50. The light diffusion layer 54 may be selected from either a layer having fine convex structures, or a diffusion ink layer having a plurality of light diffusion particles. The light diffusion layer 54 is configured for diffusing the light rays from the external light sources (not shown). In this embodiment, the optical sheet 50 may replace a light diffusion plate and two prism sheets when the optical sheet 50 is used in a backlight module. Therefore, decreasing transmission loss of the light rays in the backlight module. In addition, the backlight module may decrease the cost in manufacturing because the present optical sheet used in the backlight module may replace the light diffusion plate and the two prism sheets used in conventional backlight module.

Finally, while the present invention has been described with reference to particular embodiments, the description is illustrative of the invention and is not to be construed as limiting the invention. Therefore, various modifications can be made to the embodiments by those skilled in the art without departing from the true spirit and scope of the invention as defined by the appended claims.

What is claimed is:

1. An optical sheet comprising:
an incident surface,
an emitting surface opposite to the incident surface, and
a plurality of inverted rectangular pyramid depressions defined in the emitting surface.

2. The optical sheet according to claim 1, wherein the inverted rectangular pyramid depressions are distributed on the emitting surface in a matrix manner.

3. The optical sheet according to claim 2, wherein the inverted rectangular pyramid depressions are aligned on the incident surface side by side.

4. The optical sheet according to claim 1, wherein each inverted rectangular pyramid depression is configured to be an inverted square pyramid depression having four inner side surfaces, the four inner side surfaces having similar triangular shape.

5. The optical sheet according to claim 4, wherein two opposite inner side surfaces of each inverted rectangular pyramid depression are both parallel to a first direction, and the other opposite inner side surfaces of each inverted rectangular pyramid depression are both parallel to a second direction, the first direction perpendicularly to the second direction.

6. The optical sheet according to claim 4, wherein an inclination angle defined by one of two opposite inner side surfaces of each inverted rectangular pyramid depression is in the range of about 45 degrees to about 135 degrees.

7. The optical sheet according to claim 4, wherein the four inner side surfaces of each inverted rectangular pyramid depression cooperatively defines a valley, the valleys of the inverted rectangular pyramid depressions being curved.

8. The optical sheet according to claim 4, wherein one inner side surface of each inverted rectangular pyramid depression and an inner side surface of the adjacent inverted rectangular pyramid depression connected with the inner side surface cooperatively defines a ridge, the ridges between the adjacent inverted rectangular pyramid depressions being curved.

9. The optical sheet according to claim 1, further comprising a light diffusion layer formed on an incident surface.

10. The optical sheet according to claim 9, wherein the light diffusion layer is selected from one of a layer having fine convex structures and a diffusion ink layer having a plurality of light diffusion particles.

11. The optical sheet according to claim 1, wherein the main body is formed of transparent resin materials.
